(19) United States
(12) Patent Application Publication
(10) Pub. No.: US 2017/0166274 A1
(43) Pub. Date: Jun. 15, 2017

(54) Fixing Structure for a Lock

(71) Applicant: Sheng Yung Lock Industrial Co., Ltd., Xihu Township (TW)

(72) Inventor: Li-Yu Chen, Xihu Township (TW)

(21) Appl. No.: 15/189,431

(22) Filed: Jun. 22, 2016

(30) Foreign Application Priority Data
Dec. 10, 2015 (TW) 104219895

(51) Int. Cl. B62H 5/00; E05B 71/00; E05B 73/00

(52) U.S. Cl. CPC B62H 5/003; E05B 73/0005; E05B 71/00

(57) ABSTRACT

A fixing structure for a lock contains a flexible fixer which includes a flexible strap, a first fastener, and a second fastener. The flexible strap has a first segment and a second segment. The first fastener is fixed on the first segment of the flexible strap, and the second fastener is secured on the second segment of the flexible strap and has a through hole configured to accommodate the first fastener and the flexible strap. The through hole of the second fastener has a first inner diameter which is greater than a first outer diameter of the flexible strap and a second outer diameter of the first fastener. Thereby, the fixing structure locks a bicycle on a fixed object and obtains anti-theft of the bicycle.

### BACKGROUND OF THE INVENTION

Field of the Invention

The present invention relates to a fixing structure, and more particularly to the fixing structure for a lock which contains a first segment and a second segment of a flexible strap locked a bicycle with the lock.

Description of the Prior Art

A conventional flexible lock is employed to lock a bicycle (or a motorcycle) on a fixed object and contains a body and a flexible fixer, wherein the body is mounted on the bicycle and includes at least one locking orifice. As shown in FIG. 1, a flexible fixer 10 contains a flexible member 101, a first fastener 102, and a second fastener 103, wherein the flexible member 101 is a steel cable, a chain or a flexible strap, the first fastener 102 is fixed on a first end of the flexible member 101, and the second fastener 103 is secured on a second end of the flexible member 101. In operation, the flexible member 101 ties the bicycle and the fixed object (such as a parking post or a railing) together or ties on the fixed object solely, and the first fastener 102 and the second fastener 103 are inserted and locked in the at least one locking orifice of the body, individually, thus obtaining anti-theft of the bicycle.

As illustrated in FIG. 2, another flexible fixer 20 contains a flexible member 201 and a fastener 202, wherein the flexible member 201 is a steel cable, a chain or a flexible strap, and a first end of the flexible member 201 forms a surround lop 2011, and a second end of the flexible member 201 is in connection with the fattener 202. In operation, the second end of the flexible member 201 inserts through the surround loop 2011 so that the flexible member 201 forms a mounting band configured to tie the bicycle and the fixed objected together or to tie the flexible member 201 on the fixed object solely, and the fastener 202 is inserted and locked in a locking orifice of the flexible member 201, thus locking the bicycle securely.

In one locking manner, the first end and the second end of the flexible member 101 are locked in the at least one locking orifice of the body, and the flexible member 101 ties the bicycle to achieve anti-theft purpose. In the other locking manner, the first end of the flexible member 201 is fixed in body and the second end of the flexible member 201 forms the mounting band configured to tie the bicycle firmly. However, these two ways of flexible members only provide single locking function and cannot satisfy various using requirements.

The present invention has arisen to mitigate and/or obviate the afore-described disadvantages.

### SUMMARY OF THE INVENTION

The primary objective of the present invention is to provide a fixing structure for a lock in which a flexible strap ties a bicycle and a fixed object together or winds across the fixed object, and a first fastener and a second fastener are inserted and locked in two locking orifices of a body, wherein a through hole of the second fastener or a surround loop of a second segment of the flexible strap accommodates the first fastener and the flexible strap so that the flexible strap forms an adjustable band configured to tie the bicycle and the fixed object together or to tie the flexible strap on the fixed object solely, and the first fastener is inserted and locked in one of the two locking orifices of the body, thus obtaining anti-theft of the bicycle.

To obtain above objective, a fixing structure for a lock provided by a first embodiment of the present invention contains: a body and a flexible fixer, and the flexible fixer includes a flexible strap, a first fastener, and a second fastener.

The flexible strap has a first segment and a second segment.

The first fastener has a first end connected with the first segment of the flexible strap, and the second fastener has a third end connected with the second segment of the flexible strap, wherein the second fastener also has a through hole defined thereon and configured to accommodate the first fastener and the flexible strap.

The through hole of the second fastener has a first inner diameter which is greater than a first outer diameter of the flexible strap and a second outer diameter of the first fastener.

Thereby, the flexible strap ties a bicycle and a fixed object together or ties on the fixed object solely, and the first fastener and the second fastener are inserted and locked in two locking orifices of the body respectively, the first fastener and the flexible strap insert into the through hole of the second fastener so that the flexible strap forms an adjustable band configured to tie the bicycle and the fixed object together or to tie the flexible strap on the fixed object solely, and the first fastener is inserted and locked in one of the two locking orifices of the body.

In a second embodiment, a fixing structure for a lock contains: a body and a flexible fixer, and the flexible fixer includes a flexible strap, a first fastener, and a second fastener.

The flexible strap has a first segment and a second segment, and the second segment has a surround loop.

The first fastener is connected with the first segment of the flexible strap, and the second fastener is fitted onto the surround loop of the second segment of the flexible strap, and the first fastener and the flexible strap insert through the surround loop, wherein a second inner diameter of the surround loop of the second segment of the flexible strap is greater than a first outer diameter of the flexible strap and a second outer diameter of the first fastener.

Thereby, the flexible strap ties a bicycle and a fixed object together or ties on the fixed object solely, the first fastener and the second fastener are inserted and locked in two locking orifices of the body respectively, the first fastener and the flexible strap insert through the surround loop of the second segment of the flexible strap so that the flexible strap forms an adjustable band configured to tie the bicycle and the fixed object together or to tie the flexible strap on the fixed object solely, and the first fastener is inserted and locked in one of the two locking orifices of the body.

### BRIEF DESCRIPTION OF THE DRAWINGS

FIG. 1 is a perspective view of a conventional flexible fixer.

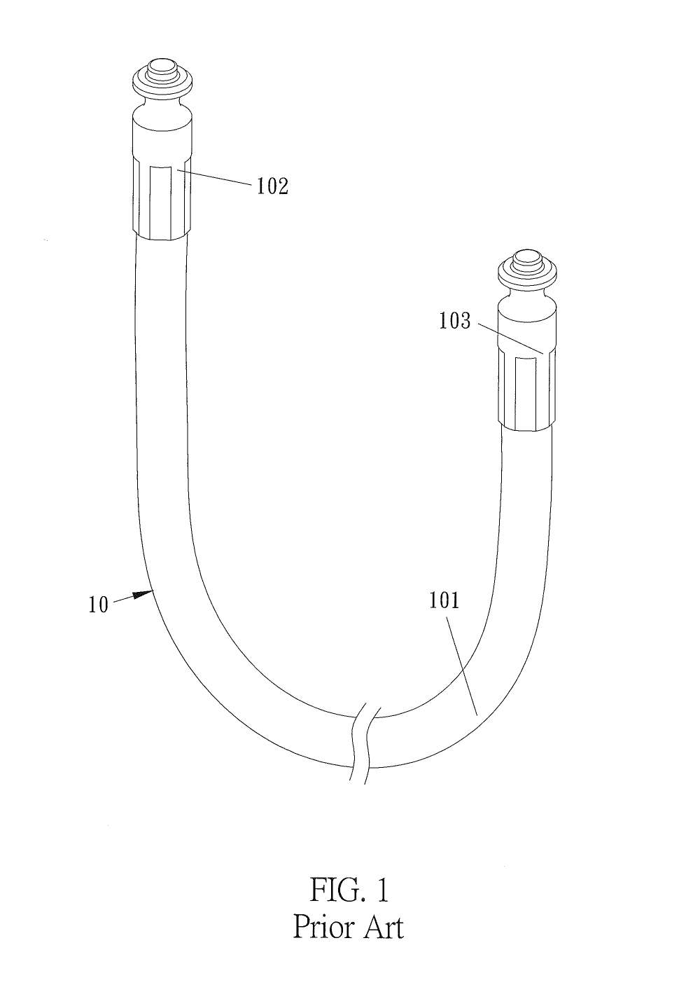

FIG. 2 is a perspective view of another conventional flexible fixer.

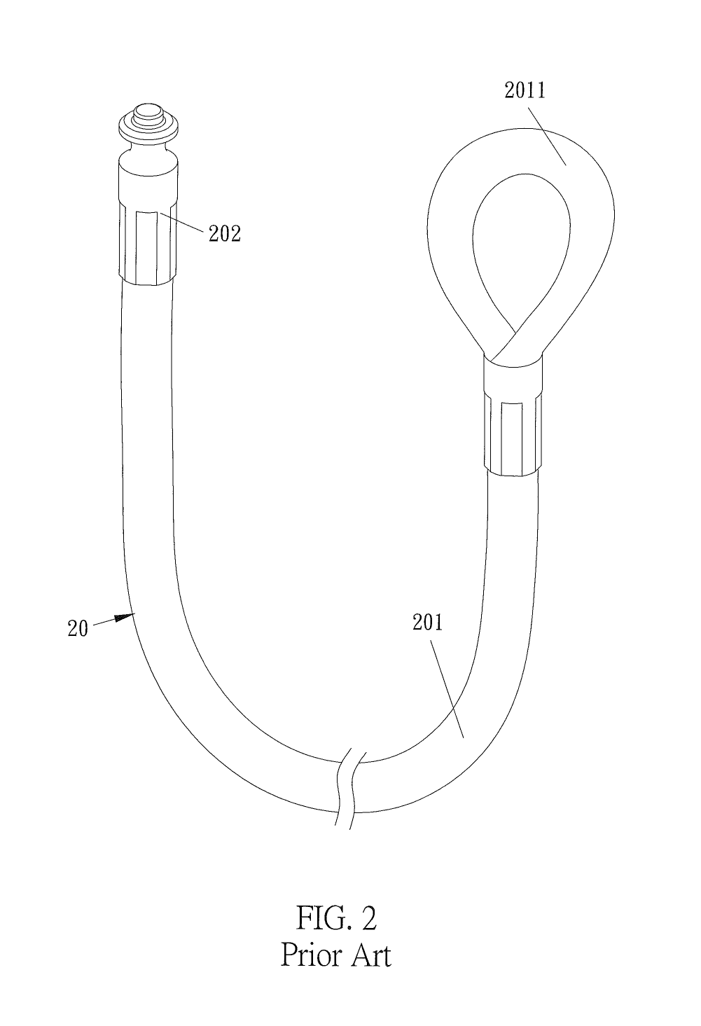

FIG. 3 is a perspective view showing the assembly of a flexible fixer of a fixing structure for a lock in accordance with a first embodiment of the present invention.

FIG. 4 is a side plane view showing the assembly of the flexible fixer of the fixing structure for the lock in accordance with the first embodiment of the present invention.

FIG. 5 is a perspective view showing the operation of the flexible fixer of the fixing structure for the lock in accordance with the first embodiment of the present invention.

FIG. 6 is a perspective view showing the application of the fixing structure for the lock in accordance with the first embodiment of the present invention.

FIG. 7 is another perspective view showing the application of the fixing structure for the lock in accordance with the first embodiment of the present invention.

FIG. 8 is a perspective view showing the assembly of a flexible fixer of a fixing structure for a lock in accordance with a second embodiment of the present invention.

FIG. 9 is a perspective view showing the application of the fixing structure for the lock in accordance with the second embodiment of the present invention.

FIG. 10 is another perspective view showing the application of the fixing structure for the lock in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

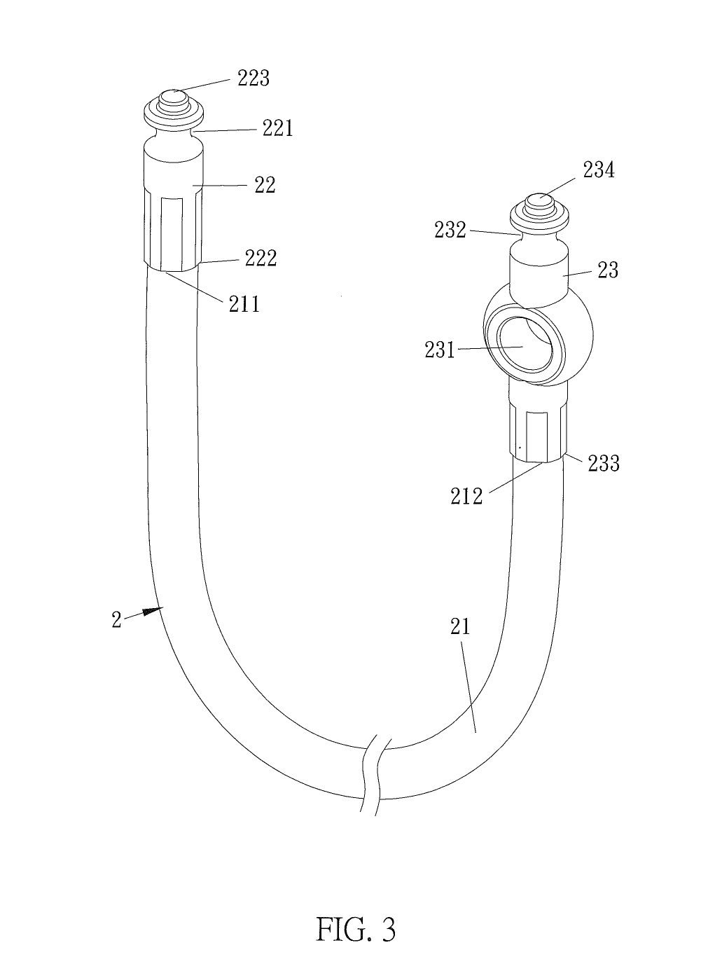

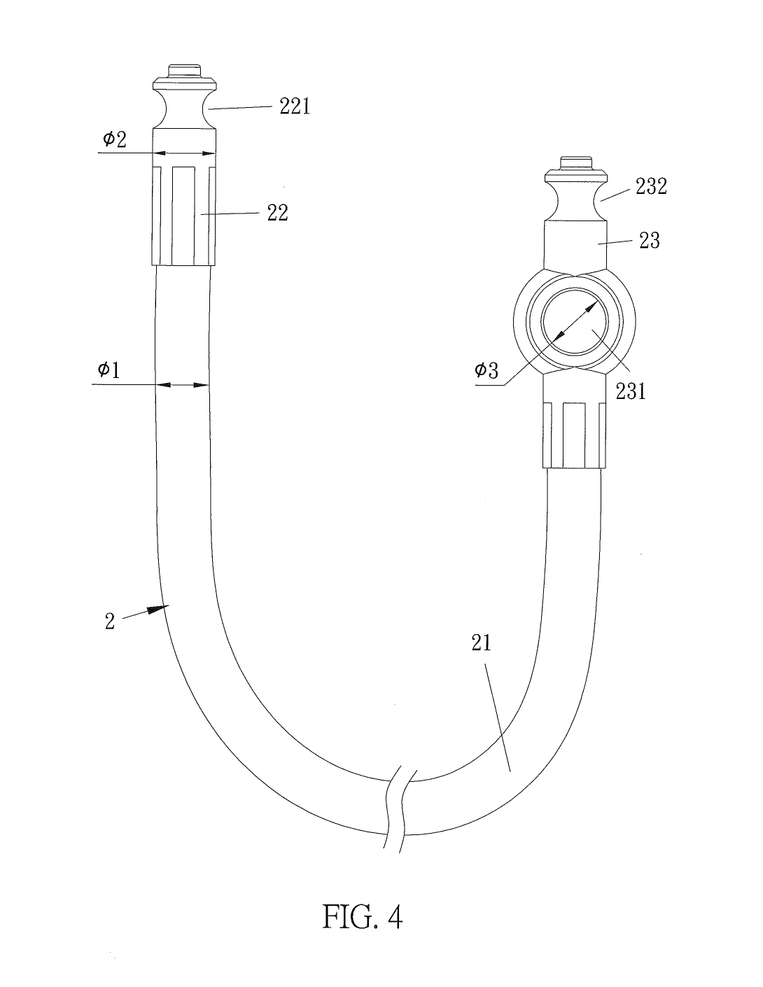

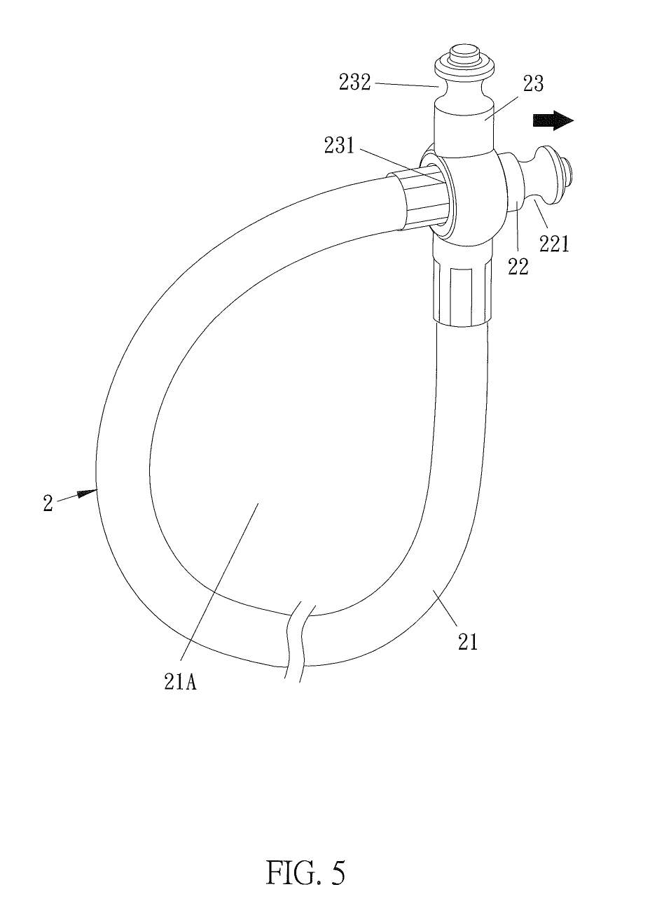

With reference to FIGS. 3 to 7, a fixing structure for a lock according to a first embodiment of the present invention comprises: a body 1 and a flexible fixer 2, the body 1 is mounted on a bicycle 3 and includes two locking orifices 11, and the flexible fixer 2 includes a flexible strap 21, a first fastener 22, and a second fastener 23. The flexible strap 21 is a steel cable or a chain and has a first segment 211, a second segment 212 opposite to the first segment 211, and a first outer diameter Ø1. The first fastener 22 has a first end 222 connected with the first segment 211 of the flexible strap 21, a second outer diameter Ø2, and a first retaining groove 221 defined on a second end 223 thereof. The second fastener 23 has a third end 233 connected with the second segment 212 of the flexible strap 21, a through hole 231 formed on an intermediate section thereof, and a second retaining groove 232 arranged on a fourth end 234 thereof, wherein the through hole 231 has a first inner diameter Ø3 which is greater than the first outer diameter Ø1 of the flexible strap 21 and the second outer diameter Ø2 of the first fastener 22, hence the through hole 231 accommodates the first fastener 22 and the flexible strap 21.

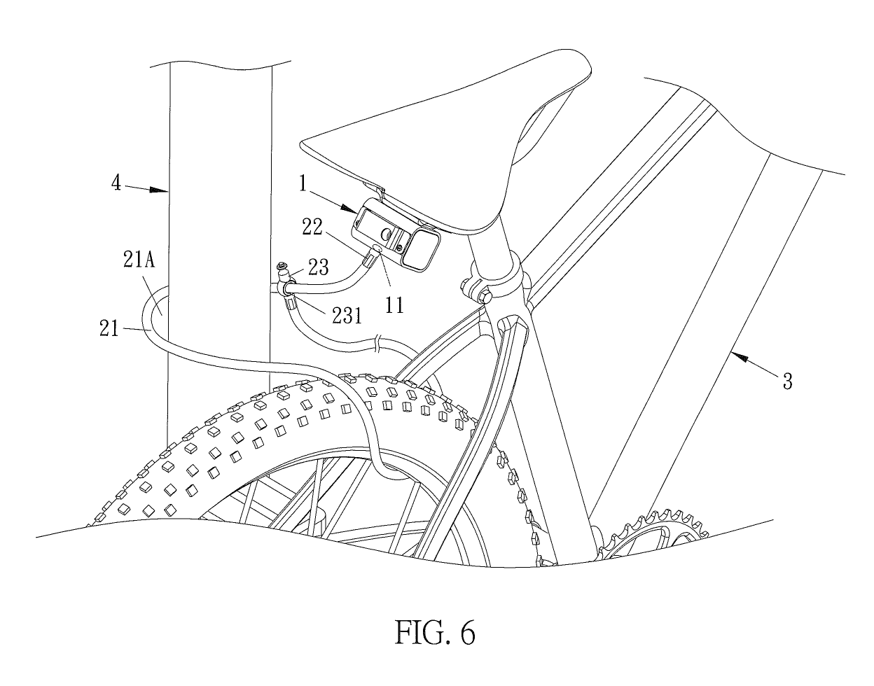

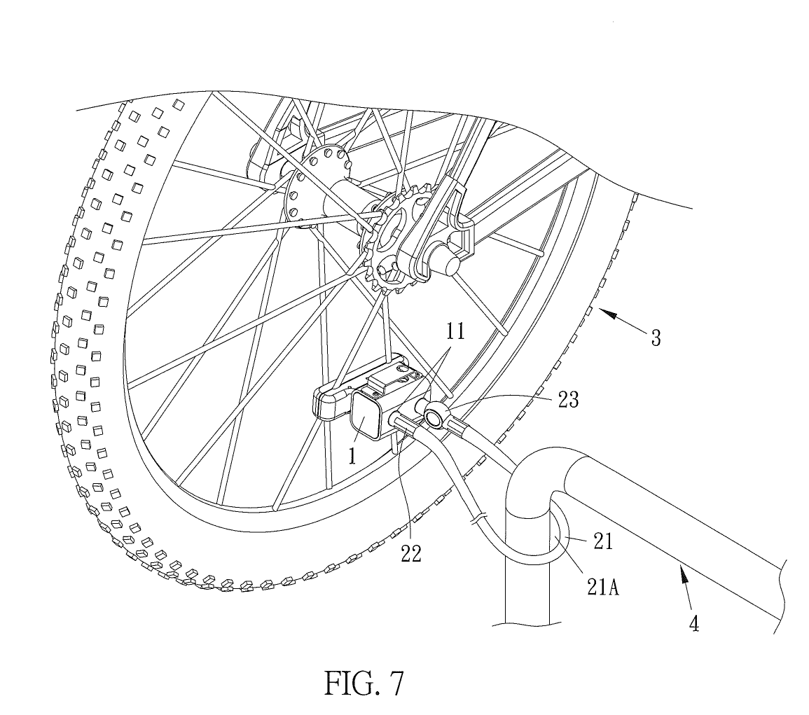

In operation, as illustrated in FIG. 6, the first fastener 22 and the flexible strap 21 insert into the through hole 231 of the second fastener 23 so that the flexible strap 21 forms an adjustable band 21A configured to tie the bicycle 3 and a fixed object 4 together or to tie the flexible strap 21 on the fixed object 4 solely. Thereafter, the first fastener 22 is inserted and locked in one of the two locking orifices 11 of the body 1, thus locking the bicycle on the fixed object 4. Furthermore, as shown in FIG. 7, the flexible strap 21 of the flexible fixer 2 winds across the fixed object 4 (such as a parking post or a railing) or ties the bicycle 3 and the fixed object 4 together, and the first fastener 22 and the second fastener 23 are inserted and locked in the two locking orifices 11 of the body 1 respectively, thus obtaining anti-theft of the bicycle 3.

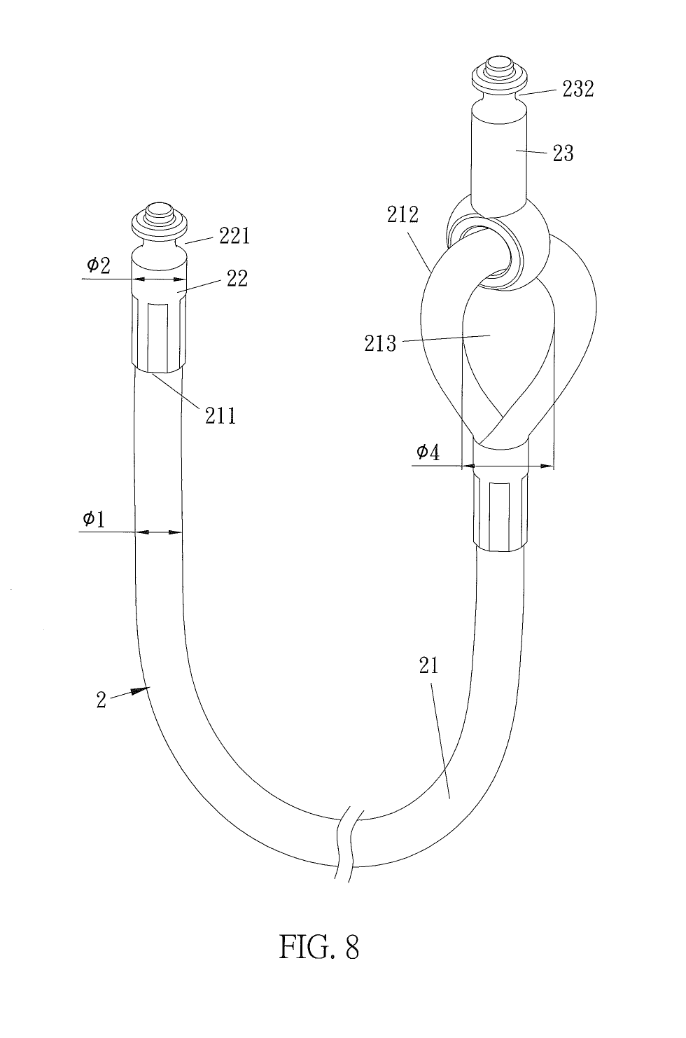

Referring to FIGS. 8 to 10, a fixing structure for a lock according to a second embodiment of the present invention comprises: a body 1 and a flexible fixer 2, the body 1 is mounted on a bicycle 3 and includes two locking orifices 11, and the flexible fixer 2 includes a flexible strap 21, a first fastener 22, and a second fastener 23. The flexible strap 21 is a steel cable or a chain and has a first segment 211, a second segment 212 opposite to the first segment 211, and a first outer diameter Ø1. The second segment 212 has a surround loop 213 with a second inner diameter Ø4, the first fastener 22 is connected with the first segment 211 of the flexible strap 21 and has a second outer diameter Ø2, and the second fastener 23 is fitted onto the surround loop 213 of the second segment 212 of the flexible strap 21, wherein the second inner diameter Ø4 of the surround loop 213 is greater than the first outer diameter Ø1 of the flexible strap 21 and the second outer diameter Ø2 of the first fastener 22 so that the first fastener 22 and the flexible strap 21 insert through the surround loop 213.

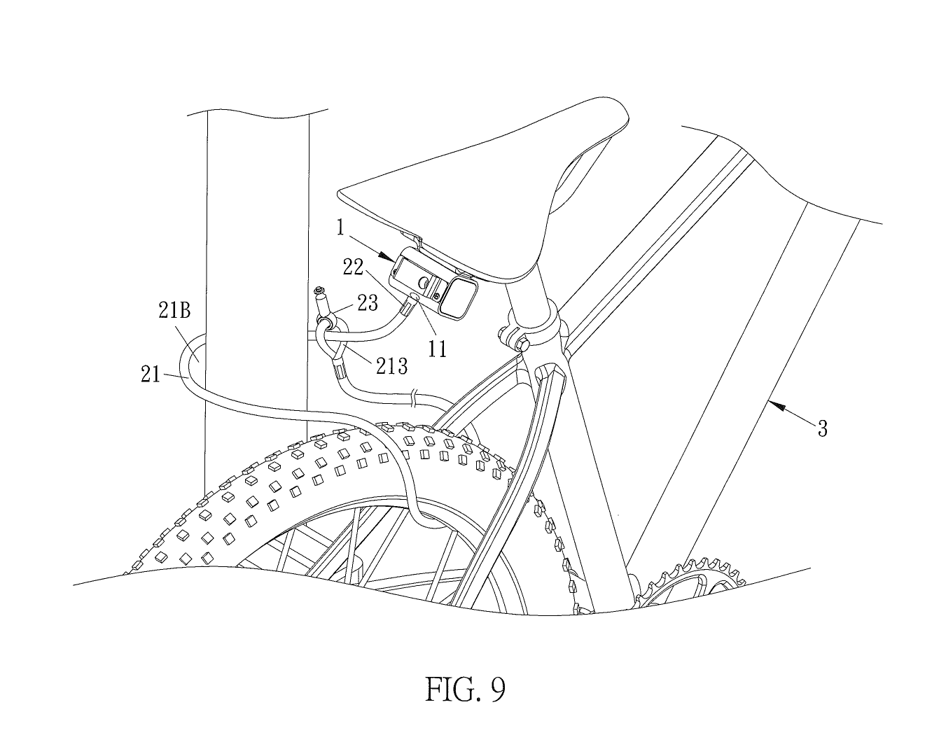

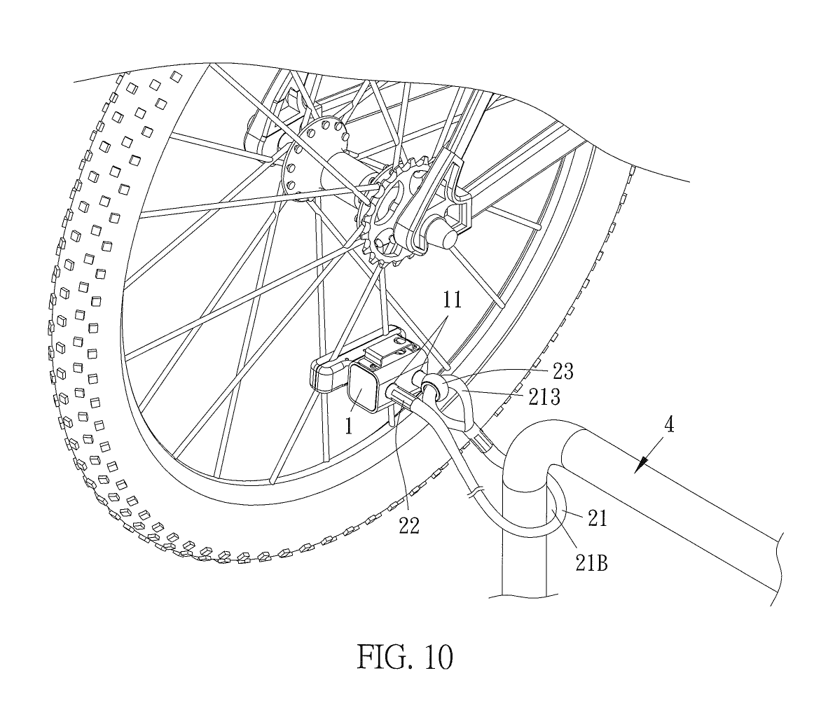

In operation, as illustrated in FIG. 9, the first fastener 22 and the flexible strap 21 insert through the surround loop 213 of the flexible strap 21 so that the flexible strap 21 forms an adjustable band 21B configured to tie the bicycle 3 and a fixed object 4 together or to tie the flexible strap 21 on the fixed object 4 solely. Thereafter, the first fastener 22 is inserted and locked in one of the two locking orifices 11 of the body 1, thus locking the bicycle 3 on the fixed object 4. Furthermore, as shown in FIG. 10, the flexible strap 21 of the flexible fixer 2 winds across the fixed object 4 (such as a parking post or a railing) or ties the bicycle 3 and the fixed object 4 together, and the first fastener 22 and the second fastener 23 are inserted and locked in the two locking orifices 11 of the body 1 respectively, thus obtaining anti-theft of the bicycle 3.

Accordingly, the fixing structure of the present invention has advantages as follows:

The flexible strap 21 of the flexible fixer 2 is applied to tie the bicycle 3 and the fixed object 4 together or is tied on the fixed object 4 solely. Thereafter, the first fastener 22 and the second fastener 23 are inserted and locked in the two locking orifices 11 of the body 1 respectively. In addition, the first fastener 22 and the flexible strap 21 insert into the through hole 231 of the second fastener 23 or the surround loop 213 of the flexible strap 21 so that the flexible strap 21 forms the adjustable band 21A, 21B configured to tie the bicycle 3 and the fixed object 4 together or to tie the flexible strap 21 on the fixed object 4 solely. Thereafter, the first fastener 22 is inserted and locked in said one locking orifice 11 of the body 1, thus locking the bicycle 3 on the fixed object 4 and obtaining anti-theft of the bicycle 3.

While we have shown and described various embodiments in accordance with the present invention, it is clear to those skilled in the art that further embodiments may be made without departing from the scope of the present invention.

1. (canceled)

2. The fixing structure for the lock as claimed in claim 3, wherein the flexible strap is a steel cable.

3. A fixing structure for a lock comprising a body and a flexible fixer, wherein the body includes two locking orifices, with the flexible fixer including:
a flexible strap having a first outer diameter, a first segment and a second segment;
a first fastener having a first end connected with the first segment of the flexible strap, a second end spaced in an axial direction from the first end, a second outer diameter, and a first circumferential retaining groove defined on the second end thereof, with the first retaining groove extending from the second outer diameter generally perpendicular to the axial direction and not through the first fastener; and
a second fastener having a third end connected with the second segment of the flexible strap, a fourth end spaced in a spacing direction from the third end, a third outer diameter, and a second circumferential retaining groove defined on the fourth end thereof, with the second retaining groove extending from the third outer diameter generally perpendicular to the spacing direction and not through the second fastener, with the second fastener also having a through hole located intermediate the third and fourth ends and configured to accommodate the first fastener and the flexible strap;
wherein the through hole of the second fastener has a first inner diameter which is greater than the first outer diameter of the flexible strap and the second outer diameter of the first fastener; and
wherein the flexible strap ties a bicycle and a fixed object together or ties on the fixed object solely, wherein the first fastener and the second fastener are inserted and locked in the two locking orifices of the body respectively, wherein the first fastener and the flexible strap insert into the through hole of the second fastener so that the flexible strap forms an adjustable band configured to tie the bicycle and the fixed object together or to tie the flexible strap on the fixed object solely, and wherein the first fastener is inserted and locked in one of the two locking orifices of the body.

4. (canceled)

5. The fixing structure for the lock as claimed in claim 6, wherein the flexible strap is a steel cable.

6. A fixing structure for a lock comprising a body and a flexible fixer, wherein the body includes two locking orifices, with the flexible fixer including:
a flexible strap having a first outer diameter, a first segment and a second segment, with the second segment including a surround loop having an inner diameter;
a first fastener having a first end connected with the first segment, a second end spaced in an axial direction from the first end, a second outer diameter, and a first circumferential retaining groove defined on the second end thereof, with the first retaining groove extending from the second outer diameter generally perpendicular to the axial direction and not through the first fastener; and
a second fastener having a third end, a fourth end spaced in a spacing direction from the third end, a third outer diameter, and a second circumferential retaining groove defined on the fourth end thereof, with the second retaining groove extending from the third outer diameter generally perpendicular to the spacing direction and not through the second fastener, with the third end slideably receiving the surround loop of the second segment of the flexible strap, with the first fastener and the flexible strap inserting through the surround loop;
wherein the inner diameter of the surround loop of the second segment of the flexible strap is greater than the first outer diameter of the flexible strap and the second outer diameter of the first fastener;
wherein the flexible strap ties a bicycle and a fixed object together or ties on the fixed object solely, wherein the first fastener and the second fastener are inserted and locked in the two locking orifices of the body respectively, wherein the first fastener and the flexible strap insert through the surround loop of the second segment of the flexible strap so that the flexible strap forms an adjustable band configured to tie the bicycle and the fixed object together or to tie the flexible strap on the fixed object solely, and wherein the first fastener is inserted and locked in one of the two locking orifices of the body.
